(19) United States
(12) Patent Application Publication
(10) Pub. No.: US 2009/0103435 A1
(43) Pub. Date: Apr. 23, 2009

(54) Dynamic rate adaptation for distributed wireless network

(75) Inventors: Ulrico Celentano, Oulu (FI); Juha Salokannel, Tampere (FI); Harald Kaaja, Jarvenpaa (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 12/289,015

(22) Filed: Oct. 17, 2008

Related U.S. Application Data
(60) Provisional application No. 60/980,637, filed on Oct. 17, 2007.

(51) Int. Cl. H04L 12/26

(52) U.S. Cl. 370/232

(57) ABSTRACT

A control strategy and/or method by which (1) a network device may reduce energy consumption though the use of lower-rate mode(s) without affecting spectrum opportunities for other network devices, which may as a result increase energy efficiency in a networked device; and (2) a network device may reduce unnecessary use of higher-rate mode(s) to allow other devices to access the common medium, which may increase usage fairness amongst devices and overall network robustness.

### RELATED CASE

This application is related to Provisional Application Ser. No. 60/980,637 filed Oct. 17,2007, entitled, DYNAMIC RATE ADAPTATION FOR DISTRIBUTED WIRELESS NETWORK (Attorney Docket 4208-4406, NC 60186), which is incorporated in its entirety by reference herein.

### BACKGROUND OF INVENTION

1. Field of Invention

The present invention relates to wireless communication, and more specifically, to strategies for maintaining wireless network connectivity in a distributed wireless system through beacons sent by each device belonging to a group.

2. Background

To maintain network connectivity, wireless communication systems may make use of beacons sent by each device belonging to a network group. In addition to communication purposes, network connectivity amongst active but unlinked wireless devices (e.g., linked to another device) operating in the same coverage or interference area may be beneficial also to improve coexistence between devices, such as by avoiding potential communication conflicts.

For example, wireless communication between devices operating in the same coverage or interference area may be maintained through a link adaptation strategy. Generally, with link adaptation the mode is switched to a stronger (and therefore slower) mode when the error rate requirements are no longer satisfied with the current (faster and weaker) mode. The transmit power may be kept constant, and as a result, the error rate performance improved at the cost of data rate. In other words, with traditional link adaptation data transmission rate is traded for error-rate. An impact of this strategy may be that while error rate may improve (e.g., errors may be reduced), the battery of a device operating in a stronger, but slower, communication mode may become depleted faster. Further, with traditional, “error-rate-triggered” link adaptation, the process is on a transmitter-receiver link basis. More specifically, control is implemented only in view of the coupled devices, and therefore, no environmental characteristics such as other devices operating within effective communication range are taken into account when determining an appropriate operating mode.

Battery operated devices need to optimize energy efficiency in order to extend the battery (charge) life and therefore the active lifetime of a network device. Increased efficiency may also help to relax requirements on battery's size and weight. In this regard, any marginal gain in battery life is worth pursuing whenever an improvement may be realized with little or no hardware alteration/addition, as well as insubstantial added complexity in general. Further, backward compatibility of future devices may be deemed important to improve the chance of success of future products that are expected to operate together with legacy devices.

### SUMMARY OF INVENTION

The present invention, in accordance with at least one embodiment, describes a control strategy and/or method by which (1) a network device may reduce energy consumption through the use of lower-rate mode(s) without affecting spectrum opportunities for other network devices, which may as a result increase energy efficiency in a networked device; and (2) a network device may release resources to other network devices upon request, for example, by moving to higher-rate mode(s) in order to allow the other network devices to access the common medium, which may increase usage fairness amongst devices and overall network robustness.

In at least one scenario, a device may change its operation from a higher-rate mode to a lower-rate mode that operates utilizing reduced power since the lower-rate mode may have better performance in terms of error rate, which may result in reduced transmit power. Under some conditions discussed below, this may increase energy conservation in a wireless device. More specifically, a higher transmit rate may be exchanged for energy efficiency in a device. Further, it is worth noting that since a longer channel time may be employed with a lower-rate mode, the overall wireless communication throughput may be substantially unaffected with possibly only a small increase in packet delay.

The exemplary method, discussed with respect to at least one embodiment of the present invention, is “transmit-power-triggered” and therefore involves the network. This is because switching to a lower-rate mode may be accomplished provided that there are free resources (MAS) left, and switching to a higher-rate mode may be done upon request of other third devices that come into the picture. Switching to a higher-rate to free resource can be also proactively done, for example, as newcomers join the group or hibernating devices wake up. In other words, a mode switching is done considering also the other devices in the neighborhood.

### DESCRIPTION OF DRAWINGS

The invention will be further understood from the following detailed description of various exemplary embodiments, taken in conjunction with appended drawings, in which:

FIG. 1 discloses an example of power consumption during transmission in accordance with at least one embodiment of the present invention.

FIG. 2 discloses bit error rate vs. signal to interference-plus-noise ratio (SINR) per bit for some example modulation and channel coding pairs in accordance with at least one embodiment of the present invention.

FIG. 3 discloses an example of activity in a device and related power consumption in accordance with at least one embodiment of the present invention.

FIG. 4 discloses an exemplary scenario for multiple connections in accordance with at least one embodiment of the present invention.

FIG. 5 discloses initial resource allocations for data transmission for the exemplary scenario of FIG. 4.

FIG. 6 discloses the initial resource allocations of FIG. 5 is modified to combine two H to one L or multiple Ls (e.g. L1, L2) in accordance with at least one embodiment of the present invention.

FIG. 7 discloses exemplary active PHY-modes set information element (AMS-IE) in accordance with at least one embodiment of the present invention.

FIG. 8 discloses an example of the mode power curve IE (MPC-IE) in accordance with at least one embodiment of the present invention.

FIG. 9 discloses an example of the resource request information element (RR-IE) in accordance with at least one embodiment of the present invention.

FIG. 10 discloses and an alternative example for the RR-IE in which the fields ESN and resource request priority (RRP) are joined into a single octet in accordance with at least one embodiment of the present invention.

FIG. 11A-11E disclose various examples of the PHY-mode change IE (MC-IE) in accordance with at least one embodiment of the present invention.

FIG. 12 discloses an example of the data PHY-modes range IE (DMR-IE) in accordance with at least one embodiment of the present invention.

FIG. 13 discloses an exemplary model for expression (1) in accordance with at least one embodiment of the present invention.

FIG. 14 discloses an exemplary model for expression (2) in accordance with at least one embodiment of the present invention.

FIG. 15 discloses an exemplary model for expression (3) in accordance with at least one embodiment of the present invention.

### DESCRIPTION OF EXEMPLARY EMBODIMENTS

While the invention has been described below in a multitude of exemplary embodiments, various changes can be made therein without departing from the spirit and scope of the invention, as described in the appended claims. Further, Applicants have provided an Appendix, included herein below, as a supplement for helping to understand any abbreviations, variables and/or terms referenced as part of the explanation in the following disclosure.

### I. Energy Consumption

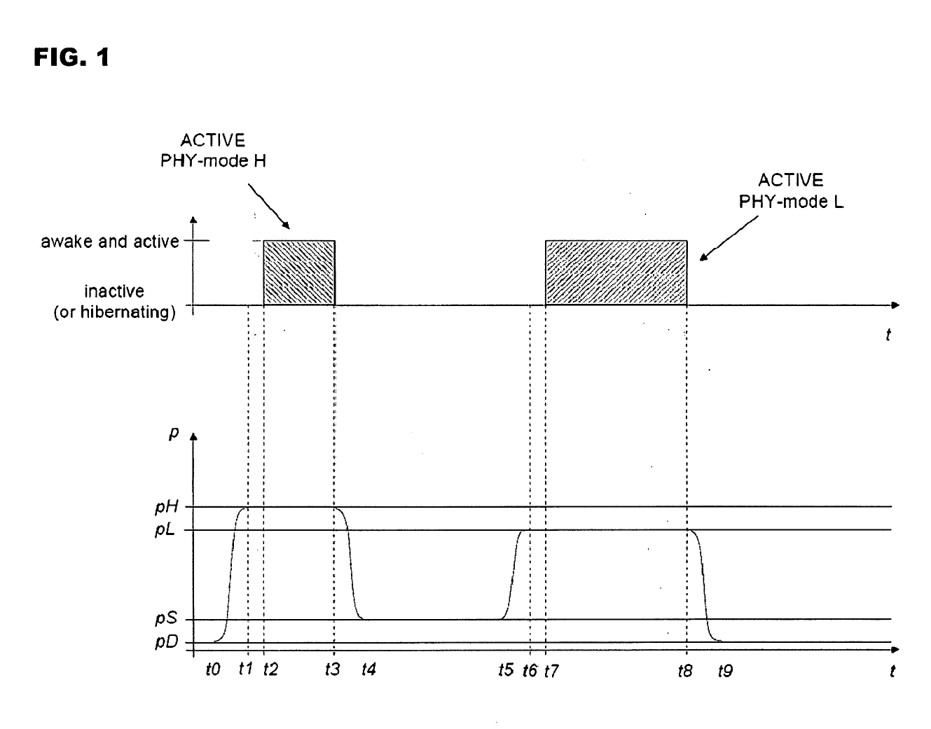

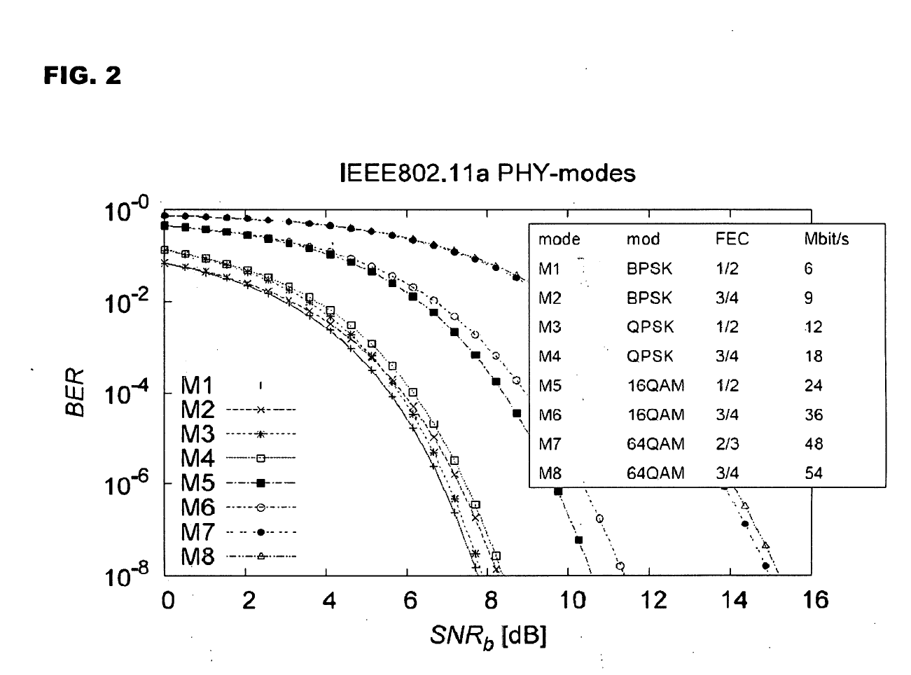

FIG. 1 discloses an example of power consumption during transmission in accordance with at least one embodiment of the present invention. In this example, two distinct PHY-modes are used in the two transmission intervals shown. When distinct modes are used, different values for power consumption may be assumed. Between the two transmissions a low power operating mode, at power level of pS, is assumed in the figure for fast activity set-up. This may be not present in a specific implementation, e.g., the difference between pS and pD may be negligible. The power levels of the FIG. 1 are indicative to illustrate an example behavior. Similar considerations apply to reception.

Different expressions for the energy consumption may be composed. The most suitable depends on the availability of data concerning power consumption of related circuitry. For example, in addition to the power consumption for transmitting, duration time tT, and for receiving, duration time tR, a term independent of the transmit rate is due to that part of the circuitry operating in the same way, duration tB, regardless of the rate used. Another component of the power consumption may be associated with the device being ready for operation.

FIG. 1 is depicts an example of power consumption during operation. Whenever the device is either transmitting or receiving, it may be deemed in an active mode. In the first active period, the device is operating at higher rate and in the second at lower rate. Those periods may include transmission, reception or both.

In the depicted example, the device is shown active for the first time between times t2 and t3. In order to be active at t2, some guard time is set and the target active time start is specified as t1. To be active at t1, some transceiver parts are put in active mode, and therefore, a first power-on ramp may be seen (e.g., the shape of all the ramps depends on the hardware and may exhibit peaks that are not shown here). The power may move from a possible lowest value pD to the operating value pH. Other measures for power saving (e.g., hibernation) have not been considered here. After the first active period, the first power off-ramp is seen. The power may proceed to a lower value pS, possibly slightly larger than pD. This is due to fact that the device is ready to go active again in short time. Alternatively, the power may return to the lowest value pD.

The device is shown active again between times t7 and t8. In order to be active at t7, some guard time may be set and the target active time start is disclosed as t6. To be active at t6, some transceiver parts may be put in an active mode, and therefore the second power-on ramp is seen. The power moves from the intermediate value pS (or alternatively from the lowest pD) to the operating value pL. After this second active period, a second power-off ramp is seen. The power goes to the lowest value pD (or alternatively again to pS, depending on the scheduled activity and/or implementation).

The power levels pS and pD may be referred to as sleep mode and deep sleep mode, respectively. The switching to one of those may depend on the time the device expects to stay in that inactive mode. It is important to realize that the present disclosure includes expressions related to energy consumption. The quantity expressed by these may not be the same, although they are, with some approximation, equivalent. The most appropriate expression may depend on the availability of data concerning power consumption of the related circuitry.

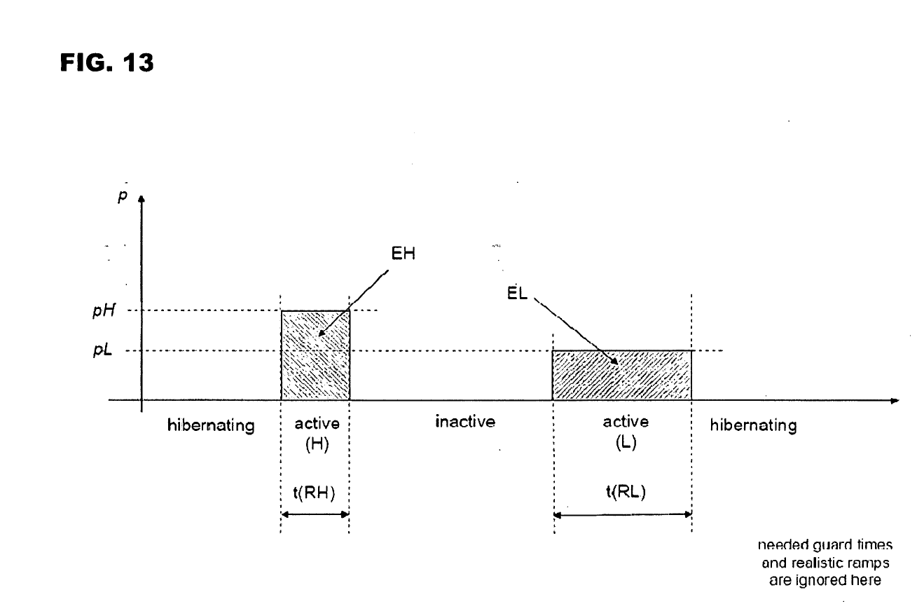

A simplified expression for the total energy consumption depends on the power consumption in each PHY-mode and the time spent using that mode (see FIG. 13):

E=EH+EL=t(RH)p(RH)+t(RL)p(RL). (1)

wherein EH is the energy expenditure in a high-rate mode, EL is the energy expenditure in a low-rate mode, t(RH) and t(RL) are the time spent using the high-rate mode and low-rate mode, respectively, and p(RH) and p(RL) are the corresponding power levels for each mode. With this expression, the energy expenditure is calculated considering the contributions to the energy expenditure when using a high-rate mode and a low-rate mode, respectively, assuming that the energy expenditure in transmission and reception is comparable.

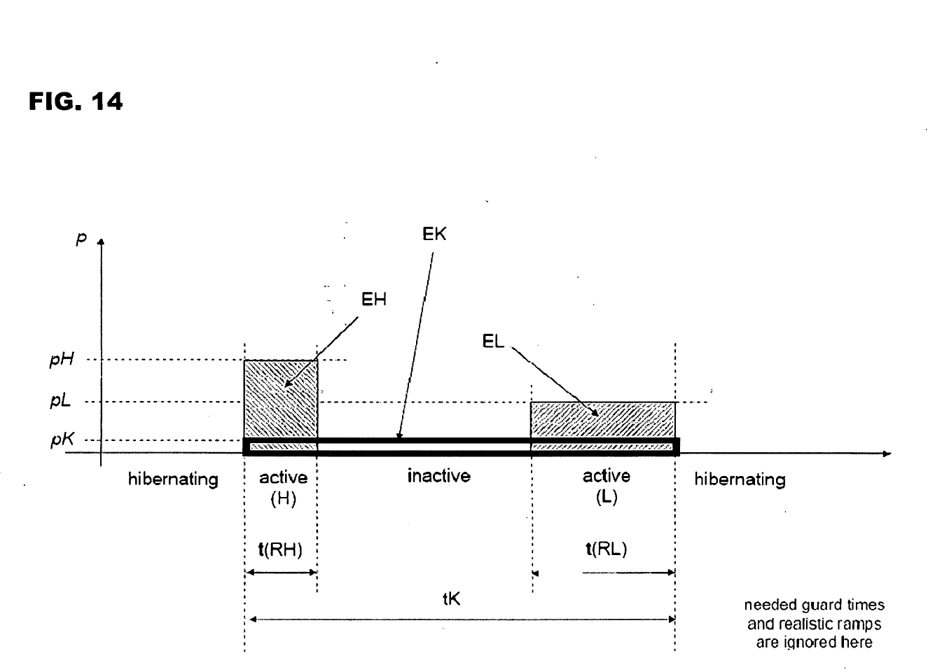

Depending on implementation and specification, the time in which substantial power may be consumed may be larger than the active time (even neglecting the ramps), as shown in FIG. 1. Therefore, a more accurate expression for the energy consumption, as further supported by the disclosure of FIG. 14, may be:

E=EH+EL+EK=t(RH)p(RH)+t(RL)p(RL)+tKpK. (2)

wherein EK is the bulk energy expenditure in active period, tK is the awake time and pK is the corresponding awake bulk power level, and EH and EL are the additional energy expenditures, not already included in the term EK, in high-rate mode and low-rate mode, respectively.

The term EK refers to the energy expenditure when the device is in awake state, but a similar contribution, although smaller, may be related to the hibernating state as well. With this expression, the energy expenditure uses the same assumptions used for the previous eq. (1), but is considering also the contribution to energy expenditure during awake but inactive time.

The absolute contribution to energy consumption of the term tKpK could be considered as substantially large, but this term is rate-independent. Also the contribution of the ramps could be considered as large (they could be also be slower than shown in FIG. 1). Both those contributions are overhead. The relative impact of the ramps may become lower as the active parts are longer. In particular, the first power off ramp and the second power on ramp may disappear completely if the activity periods get closer. For the sake of simplicity, we will ignore in the following the term tKpK as well as the ramps.

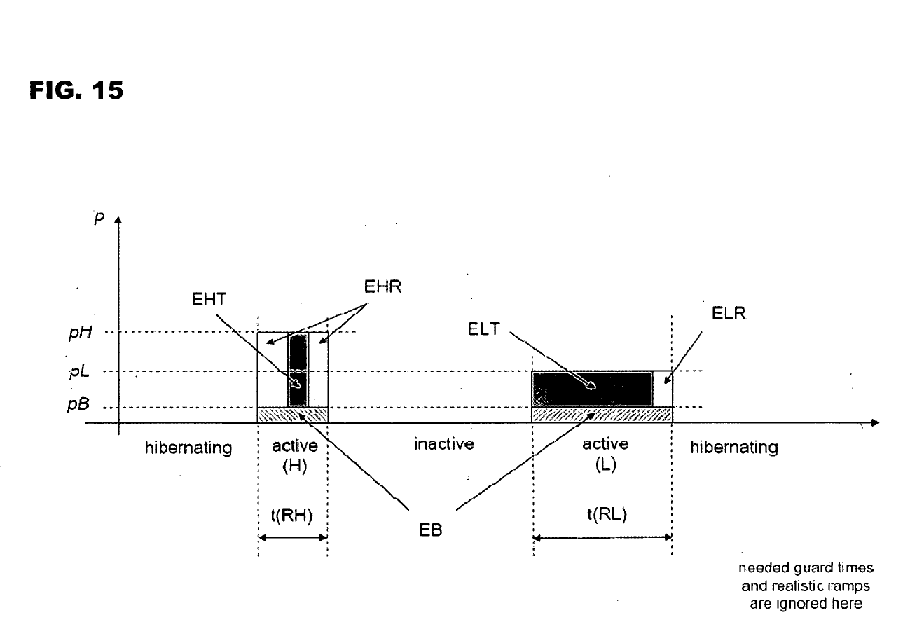

Separating the contributions due to transmission and reception, the expression for the energy consumption as further supported by the disclosure of FIG. 15 can be rewritten as:

E=EHR+EHT+ELR+ELT+EB=tR(RH)pR(RH)+tT(RH)pT(RH)+tR(RL)pR(RL)+tT(RL)pT(RL)+(tR+tT)pB. (3)

wherein EB is the energy expenditure in active mode, common to transmit and receive operations, and EHR, EHT, ELR and ELT are the additional energy expenditures, not already included in the term EB, in high-rate mode for receive and transmit operations, and in low-rate mode for receive and transmit operations, respectively. With this expression, the energy expenditure contributions are separated for transmission and reception operations when using both high-rate and low-rate modes. As in eq. (1), the contribution to energy expenditure during awake but inactive time is neglected.

In eq. (3), the first term is the energy consumption during reception at higher rate (e.g., during beacons reception), the second term is the energy consumption during transmission at higher rate (e.g., during beacon transmission), the third term is the energy consumption during reception at lower rate (e.g., during data reception), the fourth term is the energy consumption during transmission at lower rate (e.g., during data transmission). The last term in the equation above may depend on the used rate or PHY-mode only indirectly through the active time. (It has been seen in the previous sub-sections that to keep throughput constant, a lower-rate mode is associated with a longer channel time and vice versa.) Therefore this term may play a minor role. Therefore, the term (tR+tT)pB may be neglected. Without approximations, the total power consumption values during transmission and reception pR(R) and pT(R) in each mode (R=RH and R=RL) may be used if available. Those total values are used in this case for calculating the total energy consumption.

Remembering that p(R) denotes the power consumption of the transceiver at the transmit power required by the quality of service requirements in terms of tolerable error rate, it is expected, at least for transmission, that p(RL)<p(RH). (This is because higher rates may be achieved with higher order modulation constellations). It is therefore straightforward to see that using a lower-rate mode is beneficial if p(R) is superadditive. More specifically, f(x) can be defined as superadditive if f(x+y)>=f(x)+f(y). If, for example, the required transmit power for a PHY-mode B with half the rate of a PHY-mode A, is p(B)<p(A)/2, then the switching is beneficial even if the needed transmission time is doubled, tB=2tA:E(B)=tB p(B)<2tA p(A)/2=tA p(A)=E(A).

The exemplary calculation results in FIG. 2 can be used as a guideline for the impact of PHY-modes on power requirements. It can be seen that for higher-rate PHY-modes the required linear interference plus noise ratio SNR is indeed superadditive. More exact rules, including the existence of a possible minimum rate, depend on the specific performance curves. This means that, if the actual curves would possess the same properties as those in FIG. 2, there might be actually gain in switching to lower-rate mode (e.g., the required channel time may be doubled but the gain in power would be more than doubled, therefore resulting in energy gain). This 3 dB threshold is however close (this is seen from the example of FIG. 2), so the last term in eq. (3) may also play a role in the decision according to at least one embodiment.

With respect to FIG. 2, bit error rate vs. signal to interference-plus-noise ratio (SINR) per bit for some exemplary modulation and channel coding pairs is disclosed. Example schemes taken from IEEE 802.11a are plotted in the figure to refer to a realistic set. However, it should be noted that the present invention is by no means restricted to IEEE 802.11a. The error-rate curves disclosed in FIG. 2 are only examples used to demonstrate considerations that may be involved in the present invention. The curves can be replaced with a more appropriate analysis, depending on the specific implementation or embodiment of the present invention. As disclosed above, FIG. 2 shows error rate curves for an example system. Curves for other systems may differ from the exemplary curves but based on simulations they will have substantially the same shape. From these curves, it can be seen that for given error rate (e.g., fixed ordinate shown in FIG. 2) and with a lower-rate mode (e.g., looking at a curve on the left of a given/current curve) a smaller signal to noise ratio (SNR) may be required. This indicates (considering the path loss) that with given transmit power, a larger coverage is achieved. The coverage is the maximum distance that can be covered with given power and service requirements. However, this may also indicate that since a smaller SNR is required, a smaller transmission power can be utilized.

Due to the monotonic decrease of error rate curves versus signal to noise ratio, transmission with lower rate and fixed transmit power may permit a larger coverage to be achieved with given error rate. On the other hand, transmission using a lower rate and a fixed coverage radius may result in a smaller required transmission power with given error rate. The following disclosure considers fixed (or equivalently, a parameter) error rate. In other words, given a target error rate and fixed coverage radius, the required transmit power is a function of the used transmit rate, R:p=p(R). This function may be monotonically increasing in R. (e.g., because higher rates are achieved with higher order modulation constellations.) Further, different receiver structures may be required with different PHY modes (e.g., due to the different demodulator and decoding architectures). Correspondingly, also the power consumption in reception may depend on the rate used.

### II. Usage of Various PHY-Modes

In order to support backward compatibility, network devices may be required to send their beacons with a fixed, predefined rate. This rate may be larger than the rate needed or chosen for data transmission as previously discussed above. The present disclosure takes into consideration the energy expenditure in transmission and reception while using different PHY-modes regardless of the type of information carried (e.g., beacons or data). In view of the above disclosure and in accordance with at least one embodiment of the present invention, the PHY-mode with rate RH can be associated with the beacon period BP and the data transfer period DTP, and the PHY-mode with rate RL may be associated with the DTP.

### III. Resource Occupation

Transmit time will increase as the transmit rate decreases in accordance with the relationship t=t(R). If R is expressed in bit/s and t is expressed in s, then it is simply t=1/R. This implies that a larger portion of the channel time allocated for data transfer, sometimes referred to as data transfer period (DTP), needs to be counted in for that transmission. Nevertheless, in cases where the number of network devices is small, such as in sparsely-populated networks, it may be permissible for a device to occupy the channel for a longer time since the spectrum may be available for transmission for a longer time.

More specifically, availability is not only related to the population size, e.g., the number of associated devices, but also to the activity of these devices. The average occupation of channel time (Tocc) may be determined by summing the contributions over all the associated devices:

Tocc=sum(a L/R) (4)

where R is the rate used for transmission, L is the size of the data to be sent, and a is the activity factor of the device (e.g., a fraction of time expressed, for example in superframes, that the device is engaged in transmission). The occupation level OL may be defined as the ratio of Tocc over its maximum, Tdtp:OL=Tocc/Tdtp. For example, three levels of occupation may be defined according to the value assumed by OL: low, medium and high. If Tdtp denotes the channel time available for data transmission, the average channel availability (Tav) is simply given by:

Tav=Tdtp−Tocc (5)

where Tocc may be calculated in accordance with eq. (1) above. In addition to Tav, a maximum for the suitable channel time allocation request may come from the application (e.g., service requirements in terms of delay). As the number of associated devices (or devices that reactivate after hibernation) increases, and assuming those devices will also need to communicate, either devices owning a reservation need to free up resources in response to requests from other devices, for example, by at least temporarily moving to a higher rate (and therefore power), or some device will experience dropping. See also “Total energy gain”.

### IV. Total Energy Gain

In the established scenario where the use of a lower-rate may save energy, the gain may be larger as R is made as small as possible. This minimum would correspond to the case in which the time allocated for low-rate transmission is the highest possible (e.g., with a data transfer period completely filled). A device operating in this mode will have the largest activity factor, and as a result, there may be no room left for other active devices. Therefore, as other devices need to communicate, the currently transmitting devices shall attempt to free up resources, for example, by at least temporarily moving to a higher rate (if possible).

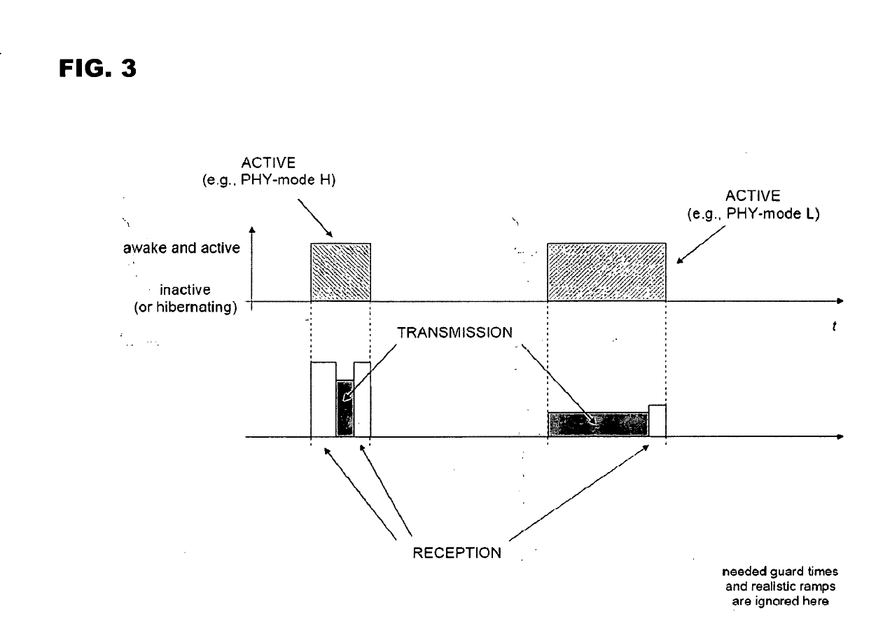

FIG. 3 discloses an example of device activity. In a first active time period the device is using a PHY-mode H and may be engaged in both reception and transmission. This may be, for example, the beacon period (BP) in which devices in a distributed network send their beacons. In a second active time period, the device may be engaged again in both transmission and reception. This may be, for example, the data transfer period (DTP) in which exchange of data is performed. In this example, transmission may be used for sending data and reception may be used for acknowledgement and/or other feedback information.

It is important to observe that the energy gain disclosed FIGS. 1 and 3 show only a portion of the total communication among devices, for example, it may refer to one superframe. If energy estimates derived using eq. (3) refer to a single superframe, the resulting energy gain may be multiplied by the number of superframes in the total communication session. However, if time in eq. (3) include the entire communication, then the resulting figure is correct.

### IV. PHY-Mode Adaptation

Regardless of the energy considerations disclosed above, when reducing R an increased portion of the data carrier channel time may be used. This means that the behavior must be made adaptive to allow devices to save energy while allowing all devices to use channel resources fairly. In other words, devices may move to lower-rate PHY-mode whenever this is beneficial for energy saving and whenever resources are available. However, those devices may move to a higher-rate PHY-mode at least temporarily, for example, in an instance where resources are needed for other devices.

In at least one embodiment of the present invention, switching to a different PHY-mode may be done by declaring explicitly the most appropriate PHY-mode to be used (e.g., MID=x). Examples for addressing these modes is described briefly below. Alternatively, the mode switching may be operated stepwise, jumping the immediately faster or slower mode, in the direction indicated by an appropriate mode transition two-bit field (e.g., MSD=xx, where 00 may indicate no change, 01 move up, 10 move down, 11 reserved).

A transition may be applied immediately from the following superframe. This can be indicated implicitly by the presence of MID or MSD, or explicitly by the presence of a specific field indicating a coming rate change, RC. Alternatively, the number of superframes after which the transition will occur may be indicated in the appropriate field, e.g., a mode switch countdown MSC=x . Those two fields MSD and MSC may be a part of dedicated information elements included in the beacon frame or in the header of other appropriate frame.

Existing wireless communication mediums may specify the PHY-mode to be supported by a device, regardless of those modes being suitable for communication under given circumstances. A sub-set of supported modes, herein called an active set, suitable for communication may be defined as follows. The lowest-rate PHY-mode may be established as the transmit rate to be sustained, and the highest-rate PHY-mode may be defined by both the transmit error rate and the channel conditions. Both rate and error rate are part of the service requirements. The active set may be indicated by a bitmap in a dedicated information element included in the beacon frame or in the header of other appropriate frame.

### V. Energy Saving Operation: Moving to a Lower-Rate PHY-Mode

A device may determine a priority indicator based on saving energy. This may be represented by the residual battery level. Assume that this “energy saving need” indicator assumes the values ESN=0 for device connected to external power and increasing levels (e.g., ESN=1, ESN=2, . . . ) for more critical conditions. This indicator may be computed and used locally or may be advertised, e.g., in its beacon sent during the beacon period (BP). Based on the knowledge of ESN values in other devices, a decision may be made in a distributed manner as to which device(s) will proceed first with lowering the rate, and thus, occupying more channel time. Upon reception of an ESN larger than zero, devices may proactively start freeing up resources by increasing the rate.

A transmitting device (or a transmitting-receiving pair) with the largest ESN indicator (or sum of ESN values) may compute if the channel time left unused is enough to compensate for the decrease to a lower-rate PHY mode. If this is possible, that device may start a procedure to acquire the needed channel time. This may include advertising its intention by properly setting an information element (the mode change IE, MC-IE) included in its beacon. This IE may include all or some of the ESN, RRS, RRD, DevAddr, RRP, RC, MSC, MSD, and MID fields. Other methods defined by a target standard may also be used for this scope. The initiation of these procedures may be advertised by a proper indicator. For example, the rate change indicator RC=0 may indicate normal operation and RC=1 may indicate a coming change in rate. With a finer time resolution, RC may be replaced by MSC. The device may update the indicator of the PHY-mode to be used next, determined based on the unused channel time.

A multitude of rates and/or PHY-modes in general may be available at the device. The rate or PHY-mode that the device will use in the data part may be advertised in the beacon part and properly indexed. This may be indicated by, e.g., a mode ID (MID) or current mode (CMD) field. Alternatively, the next mode may be implicitly indicated as the immediately lower mode in the AMS list (this corresponds to the use of the MSD fields, not needed here since the direction is implicit). The maximum-rate mode may be implicit from the AMS list, if available. Alternatively, it may be explicitly indicated by, e.g., the MMD field. CMD and MMD may be part of the data PHY-modes range IE (DMR-IE). The MMD may be equivalent to the highest-rate PHY-mode ID in the AMS-IE. However, the AMS-IE might not always be available; MMD is needed if the AMS is not available. The overhead related to the addressing of PHY-modes may be reduced by properly defining an active mode set and addressing an element in that space.

VI. Fairness Operation: Changing Modes to Free up Resources for other Devices

Other devices may also need resources. Resource sharing can be based on proactive or reactive methods and policies that define the limits of those methods. A policy may be set different for using different PHY-modes. For example, there is a policy defined for channel reservation made for PHY-modes defined in WiMedia 1.0, but the policy for lower rate PHY-modes could be different. In another example, there may be more or less safe reservations guaranteed for lower PHY-mode use than for PHY-modes defined in WiMedia 1.0. Such different policies could be applied directly in WiMedia 1.0 type of reactive method. In proactive methods, the policy would define a trigger level after which (parts of) reservations must be released without an explicit request. Triggering a release of unsafe reservations proactively may be based on information received from neighborhood, such as number of neighbors, other DRP reservations, TIM IEs indicating PCA use, a number of DRP reservations or TIM IEs or amount of MASs seen reserved in neighbors' DRP IEs, or other indications as defined in this application.

Any device that needs channel time may request resources from any other device that has more channel time than the network and/or wireless communication medium policy guarantees. This can be understood by current devices in an implicit or and explicit way. Other devices may explicitly require resources to be freed. This can be done by properly setting a flag in the beacon, e.g., a “release resource request” (RRR) may be indicated by an ESN field with content other than zero, or even as a separate IE like in a Relinquish Request in WiMedia 1.0. This information may optionally be integrated by the content of a specific field declaring the amount of resources needed (e.g., RRS). This information may optionally be integrated by a specific field declaring the amount of time the resource is requested. This may be indicated, e.g., by a field RRD (expressed in superframes, seconds, etc.). The inquiring device shall then release the newly acquired resource by the RRD (seconds or superframes). The operation described above is a so-called implicit RRR. The same information as above may alternatively be included in a specific frame or message. Other methods defined by a target standard may also be used for this scope.

Upon reception of a resource release request, devices that are able may release resources for use by the requesting device. For example, devices using a lower-rate PHY-mode and which have capability of using a higher-rate mode may move, at least temporarily, to that higher-rate PHY-mode (e.g., such device shall release the resources as described below, but it may alternatively decide not to change its PHY-mode). This transition may be immediate (e.g., from the following superframe), or it may be scheduled for a given time (e.g., declared by the mode switch countdown MSC defined above). If no RRS-type information is provided, the release procedure may be iterative, in that the device using the lower-rate PHY-mode may move to the immediately higher-rate mode, at least temporarily, until the newcomer device declares a ESN=0 status. In at least one scenario, a device attempting to conserve energy (e.g., by operating in a lower-rate mode) may release only a small amount of resources to other devices if no exact resource release amount is requested. For example, the device may operate in a higher-rate mode for only a short period of time before returning to a lower-rate mode. Then, the device may listen for further resource requests from the other devices, and may repeat this process accordingly. In this way, the device needing to save energy (e.g., due to a low battery power situation) may maximize its operational time in a lower-rate mode while still attempting to address urgent resource requests from other nearby devices. The release procedure may be done according to proper priorities, specifying an order by which devices shall increase their rate. The address of the target device may be indicated by DevAddr field in the RR-IE. This is a so-called explicit RRR. In alternative, or in conjunction with priority rules, devices that are able to change their PHY-mode may be identified with the CMD and MMD fields in the DMR-IE. Those fields may be sent in each beacon or only when acquisition or release of resource is occurring.

Using CMD and MMD, an inquiring device may understand that a target device may release channel time without affecting its service quality (service quality, with respect to at least delay, may even improve slightly). For example, a reservation may be declared as safe when the channel time is strictly required by the application (this is done by setting to zero the unsafe bit in the DRP control field). This means that the application will not work properly or will not work at all with less resources assigned. Additional reservations may be declared as unsafe if they are not strictly required by the application. This same concept of safe vs. unsafe may also be introduced in other standards or system specifications. The entity of unsafe and safe portions of a reservation may be in general unknown or that information may not be available. In this scenario, the device may perform an implicit RRR as disclosed above.

In view of the above, a device in need of resources may issue a release request in view of the status of unsafe reservations. If unsafe reservations with a duration longer than its requirements exist, that device may select the smallest of those and may do an explicit RRR by setting the DEV-ID field: RR-IE.DevAddr. If unsafe reservations with a duration longer than its requirements do not exist, but more unsafe reservations would satisfy it, that device may select the smallest number of devices and do an explicit RRR for each target device. For example, an explicit RRR may take X superframes (SF) to complete. In superframe 1 device DEVA declares a portion of its current reservations as unsafe. In the same superframe, DEVB makes an explicit RRR towards DEVA (e.g., having an ESN>0), and at the same time makes a regular reservation (e.g., a DRP reservation) for the same portion of channel time. Within XSF's, DEVA may have released the slots and DEVB may start using those slots. X could be as small as two, but may be defined as mUnsafeReleaseLimit to be four SFs in some existing wireless communication mediums. However, since a PHY-mode change may need to be negotiated and/or synchronized between DEVA and its counterpart, values larger than two may actually be needed.

In addition to, or alternatively to, the operational rules disclosed above, the decision of a device target for an explicit RRR may be based on selecting a target device that may suffer the smallest energy loss due to PHY-mode switching, or that has the largest residual energy, etc. This selection may require knowledge of the candidate target device's p(R) curve, which is discussed further below.

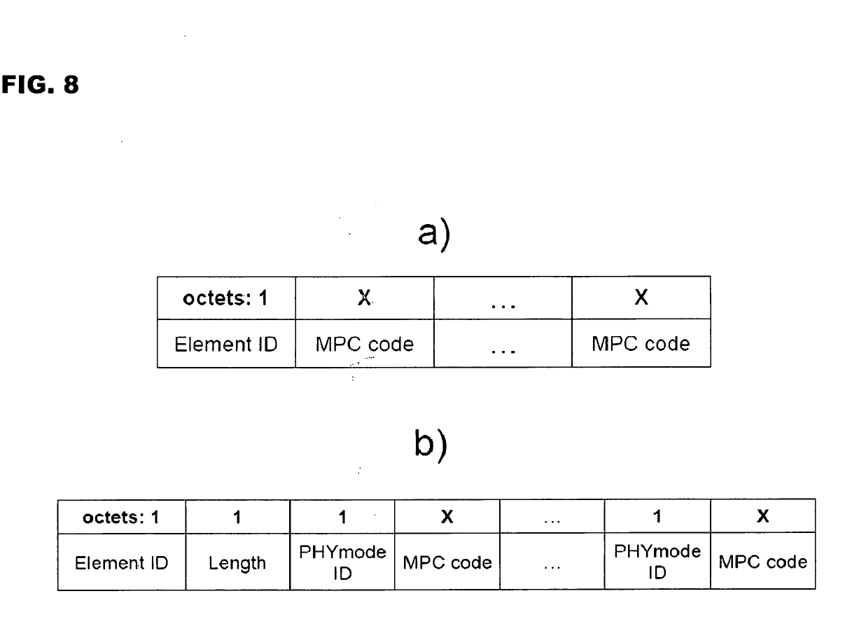

The smallest energy loss is obtained by considering the PHY-mode that has a rate just high enough to free the amount of channel time needed by the enquiring device. The enquiring device shall assume for its calculation the use of its highest allowable rate as indicated by its active set. The energy savings may be determined using the same laws used for link budget calculation. All the needed information is known to all devices when both the current PHY-mode in use and the possible PHY-modes (e.g., indicated by the active set) are known. This assumption may be true at no overhead when similar implementations may be assumed. Alternatively, some information of p(R), may possibly coded and provided (e.g., as an element of the vector mode power curve (MPC) vector) included in the MPC-IE. The actual curve for a given type may be coded in the device's memory. The MPC vector (as disclosed in exemplary FIG. 8a) may be sent together with the AMS vector or alternatively upon request of other devices. Alternatively, a device may send one or more codes (as disclosed in exemplary FIG. 8b). In particular, the MPC-IE may be sent in all beacons sent by a device. Alternatively, this IE may be sent proactively only as one or more newcomers join the group, or one or more devices are back awake from hibernation. Yet in a further scenario, the MPC-IE may be sent upon request of a device. This request should come before a following resource request

An explicit RRR may be indicated by ESN>0 in the resource request IE, RR-IE, together with a valid DEV-ID in the DevAddr field. In the implicit RRR, ESN>0 but the DevAddr is set with a properly specified “invalid” ID. The previous may be deemed a soft RRR. If unsafe reservations are not sufficient for the device, a so-called hard RRR may be performed. This may be a pre-emptive operation by which a device requires a device assignee of resources to release some of them. The selection of the target device(s) may be done using information on that (those) target device(s) and the inquiring device on traffic priorities, etc. For example, the priority of the enquiring device may be included in its IE with the field RR-IE.RRP. The soft RRR may be distinguished by a properly specified “invalid” priority code. Alternatively, it may be implicitly indicated by a missing RRP field in the RR-IE.

In another exemplary scenario, transmitting device A may move to proactively free up resources when changes are experienced in the network. For example, transmitting device A may move to a higher-rate PHY-mode to free resources when at least one new device “C” joins the group. This operation (device A moving to higher-rate PHY-mode) may be conditioned on information included in the beacon of device C, or alternatively, a relevant indication may also include when device C sets TIM IE. An example of this, may be the contents of the traffic indication map information element (TIM IE) specified in WiMedia 1.0 [Ref to ECMA-368: ECMA International, High rate ultra wideband PHY and MAC standard, Standard ECMA-368, 1 st ed., December 2005]. For example, device C may have set an ESN field with content other than zero, or device C may have declared a time-critical application type, etc. This proactive operation may allow prompt usage of resource for data transmission for newcomer devices. After a given time, YYY seconds, if device C has not used any resources, device A may move back to the settings utilized before device C joined the group.

### VII. Multiple Connections

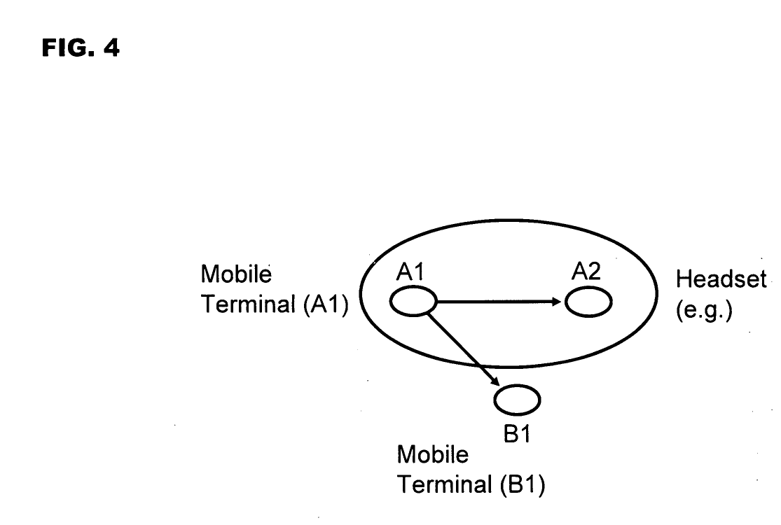

FIG. 4. discloses an example of multiple connections in accordance with at least one embodiment of the present invention. In this example devices DEVA1 and DEVA2 may belong to the same physical user. A third device DEVB1 may also be part of this example.

Consider the scenario of FIG. 4 in which a device DEVA1 may be engaged in transmission towards two devices DEVA2 and DEVB1. The DEVA1-DEVA2 pair may be owned by same person and is also referred to as MyDevices. In this case, the criteria to use for mode switching may be slightly different, for example, because the goal may be to optimize (minimize) the global energy consumption or the lifetime of MyDevices. As part of this determination, DEVA1 may evaluate whether it is more appropriate to change the mode of RL (e.g., move it to a higher power link for more saving) or to change the mode of the closer link with DEVA2, where power savings will also be realized. The expenditures may be computed similarly to a single-connection case. However, in this case there is an additional degree of freedom in modifying the operation of a physical side (in this case, the device pair DEVA1 and DEVA2) having more connections. For example, a switching criterion may include different ways of selecting one or many links to be moved from the higher-rate PHY-mode RH to the lower-date PHY-mode RL, or of exchanging only some allocations to a different mode.

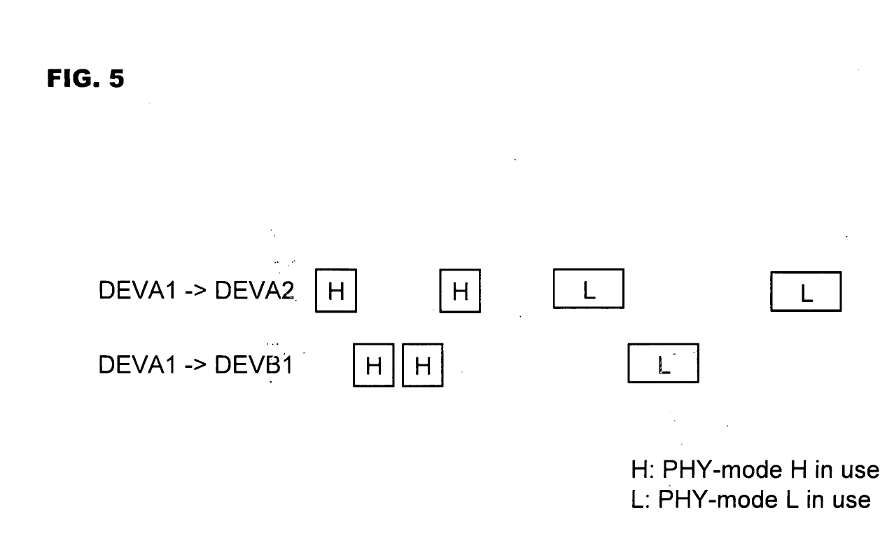

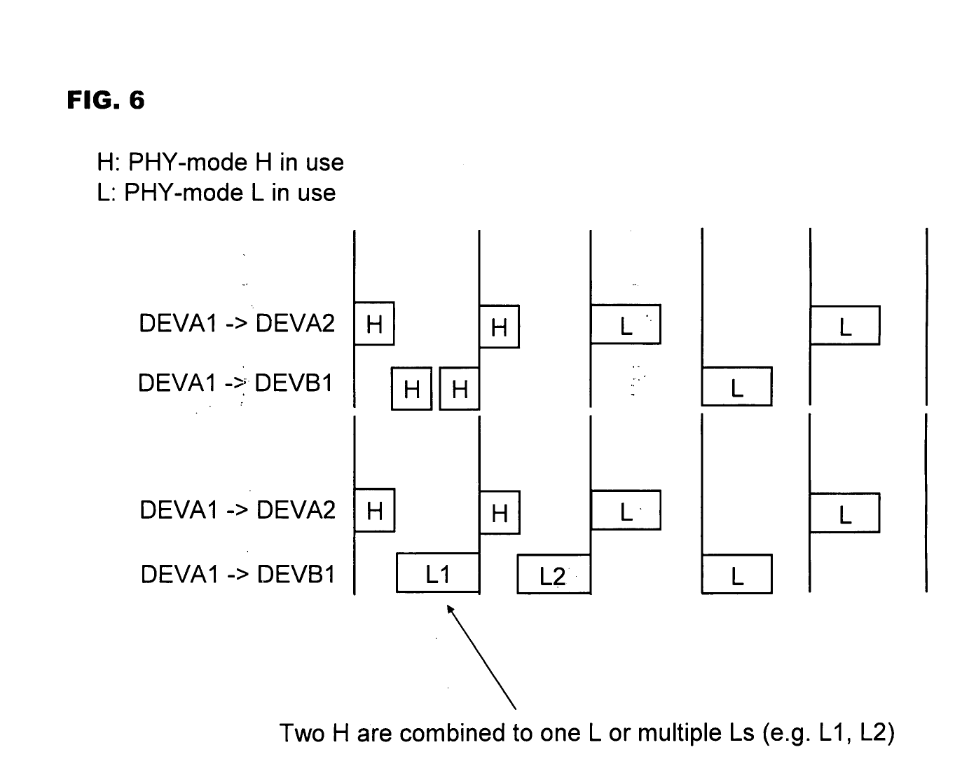

Now referring to FIG. 5, there are two connections: DEVA1-DEVA2 and DEVA1-DEVB1. This may be compared to FIG. 6 where two allocations using the higher rate RHare combined to multiple Ls (L1, L2). The expenditures for the beacon period BP (i.e., sending one beacon and receiving the entire BP) are unchanged and the data transfer periods (DTP) between DEVAl and DEVA2 are also untouched in FIG. 6. Therefore, the only changes are in the expenditures of DEVA1 and DEVB1. The same expressions for the single-connection case still apply here. Further, in FIG. 6 the allocation of FIG. 5 is modified to combine two H to one L or multiple Ls (e.g. L1, L2). In particular, for DEVA1→DEVB1 transmissions, two H periods and one L period are replaced with the two L periods L1 and L2. In other words, the data sent in FIG. 5 during the two H periods is now sent during L1. It is important to note that the length field in some of the following IE may be not needed in some implementations.

The above assumes that there is room in the superframe (SF) for mode switching. This may not always be the case. Assume that the link DEVA1-DEVA2 is already using the lowest rate PHY-mode. Assume that DEVA1 may want to switch to a lower-rate mode with rate RL for the link DEVA1-DEVB1 as well. However, assume also that there is not enough room in the DTP for this change. Therefore, the slots used for DEVA1-DEVA2, should be moved from RL to RH before moving DEVA1-DEVB1 allocations from RH to RL.

The MyDevices pair may optimize the choice by observing and reacting to the following. The optimal choice may (e.g., do the switches or keep the current status) depend on the specific transmit power used and on the length of the DTP reservations on both links. Typically, DEVA1 and DEVA2 are closely situated (since they are the MyDevices belonging to the same physical person) and therefore a smaller transmit power would be acceptable in maintaining communication. The relative gain in halving the power may typically be larger for the DEVA1-DEVB1 link, at least without considering the length of the reservations. In other words, it may be better to have DEVA1-DEVA2 @RH and DEVA1-DEVB1 @RL. Another criterion may be based on the residual battery levels for DEVA1 and DEVA2. If DEVA1-DEVA2 is moved to RH, then DEVA2 might run out of battery, which may impact the operation of DEVA1 as well.

### VIII. Additional Notes Concerning Implementation in Possible Future Versions of ECMA-368

The explicit resource release request previously disclosed above may be similar to the relinquish request specified in WiMedia 1.0. This means that the proposed resource release, for example, by at least temporarily moving to a higher-rate mode may be implemented in possible future versions of ECMA-368 as an extension and/or modification of current relinquish request mechanisms.

A device may compute the channel time requirements (number of MASs) according to the highest possible rate, MMD. This rate may depend on both the available PHY-modes and a target error rate. Based on the available PHY-modes and on service considerations, the required number of MASs may be determined: nH=tH/tM, where tM is the MAS duration and tH=L/RH, where L is the number of bits to be transferred during one superframe. If there is available channel time, the device may use a lower-rate PHY-mode, CMD, to improve energy consumption (e.g., service quality in terms of average packet error rate may slightly worsen). The new values may then be computed as: nL=tL/tM, where tL=L/RL. The device shall request the corresponding nH MASs as safe and nL-nH MASs as unsafe. CMD and MMD are available locally but they may be part of a newly defined IE or even be added to the DRP-IE.

Currently, a relinquish request may be issued to request the target device to release the allocation. An inquiring device may use the relinquish request IE also to require a device to increase its rate to free resources, according with the proposed mechanism. The RR-IE.DevAddr defined above is in this case the Target DevAddr field in the relinquish request IE. The reason for resource release request may be indicated by using some of the reserved bits of the reason code of the relinquish request control field of the relinquish request IE, defined in WiMedia 1.0.

The current specifications define the maximum rate to be used for data transfer (see Sect. 17.11). This means that a slower rate may be used. Minor changes to current specifications are needed concerning issuing the command, bigger changes are needed about behavior upon reception. Indeed, in addition to releasing the unsafe slots, the target device may need to negotiate and/or synchronize with its counterpart the new PHY-mode. The above defined RC flag is associated with the operation of modification of the current DRP reservation.

The priority code used for pre-emption in the hard RRR defined above is similar to the reason code in the relinquish request control field in the relinquish request IE specified in WiMedia 1.0. In this case, the requested AMSs may include also those marked as safe. Other standard-related parameters and structures involved with this invention may include: pBeaconTransmitRate, PHY capabilities IE and Link Feedback IE. The above modifications to the specifications are needed at least in the following sections: 16.8.6 (setting the unsafe bit), 16.8.18 (redefining the behavior and adding the new reason code), 17.1.10.17 (redefining the behavior), 17.4.7 and 17.11 (changing the PHY-mode and using different PHY-modes), B.2 (reservation limits and general rules concerning this proposal). Moreover, the following sections of the specifications are relevant to this invention: 16.8.11 and 16.8.16 (transceiver capabilities and link feedback), 17.16 (MAC sub-layer parameters). The emphasis on implementation in WiMedia is here on DRP, although the implicit RRR may be applicable to WiMedia's PCA or other similarly situated wireless communication mediums.

### IX. Possible Information Elements According to at Least One Embodiment of the Present Invention

Information elements usable in accordance with at least one embodiment of the present invention follow below. The information included in these information elements may be part of the beacon frame or can be put into other appropriate frames as described above. The disclosed information element sizes are indicative for explanation purposes only in the present disclosure and may be changed in accordance with various implementation factors.

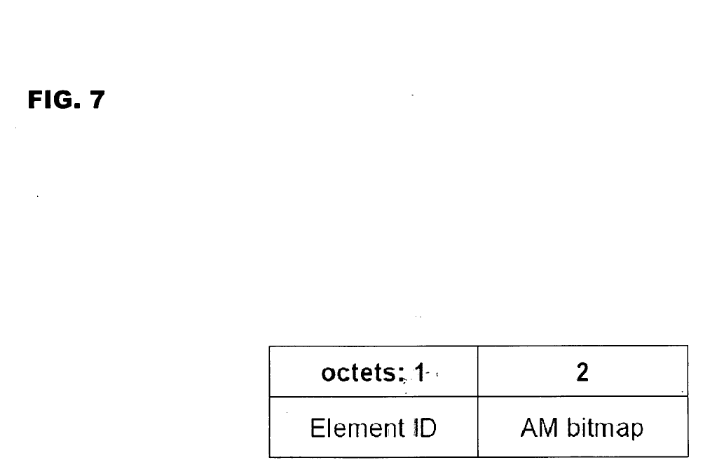

AMS-IE: active PHY-mode set. List of the PHY-modes possibly used. This list is a sub-set of a possible list included in PHY capabilities IE. The AMS list may be a list of PHY-modes' IDs or a bit-map similar to the one possibly used for PHY capabilities, or only first and last mode may be indicated/addressed. The way the active PHY-modes are chosen is specified in the PHY-mode adaptation text. The difference between PHY capabilities and AMS is that PHY capabilities indicate the supported PHY-modes and the AMS indicates the usable modes (e.g., for quality of service, QoS, purposes). In this latter case, the size in bits in the number of supported modes. In FIG. 7, Active PHY-modes set AMS-IE. The AMS-IE is made of a single field including a bitmap. With up to 16 modes, one or two octets may be sufficient. If more modes are present, the AM bitmap may correspondingly occupy more octets. The bits in the bitmap may assume the value 0 for inactive and 1 for active.

MPC-IE: PHY-mode power curves codes. This optional IE enriches the information that may be provided by the AMS-IE. A device may send this IE in all beacons. Alternatively, this IE may be sent proactively only as newcomers arrive, or hibernating devices are back awake. In a further optional configuration, the MPC-IE may be sent upon request of a device. This request comes before a following resource request. The codes included in the MPC-IE are used to characterize the power consumption curve p(R). The type of the power consumption curve p(R) is used to determine the candidate target device's energy loss. The size of these codes depends on the number of curve types, which in turn depends on the number of supported modes and the accuracy with which they are approximated (e.g., the actual curve). Two implementations are considered. FIG. 8. discloses an example of the mode power curve MPC-IE. In case a) the codes for all the active modes included in the AMS-IE are declared. The length of a single MPC code is not specified here. In the alternative case b), the code is declared only for one or more PHY-modes. The efficiency of a particular method may depend on the size of the MPC code, the number of modes included, etc.

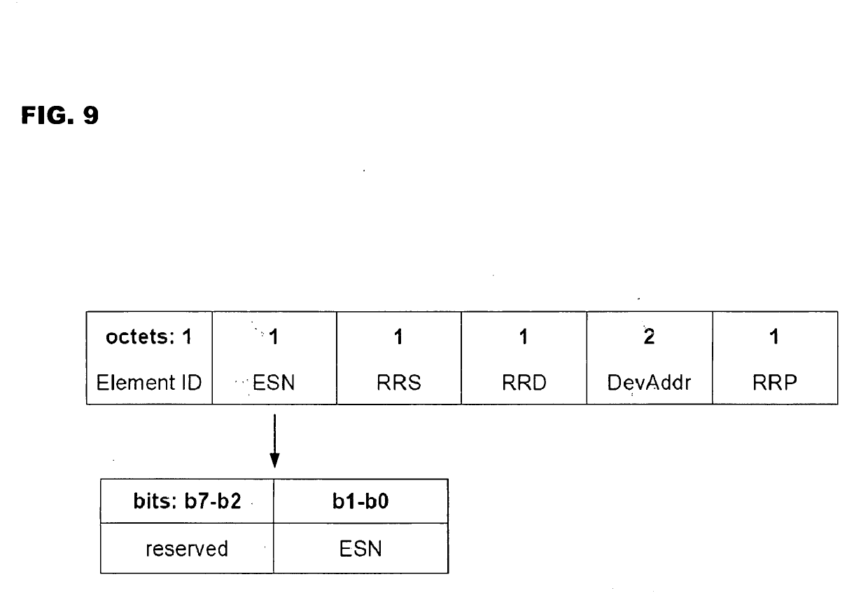

RR-IE: resource request IE. This information element may include the following fields: ESN, RRS, RRD, DevAddr, RRP. Depending on the type of the RRR such as implicit, explicit, and hard, not all the field may be present. Alternatively, one distinct IE for each on those cases may be specified. FIG. 9 discloses an example of RR-IE, including the octets that may be included in the message and additional detail on the bitwise content of the ESN octet. Depending on the type of the RRR (e.g., implicit, explicit, hard), not all the field may be present. Alternatively, one separate IE for each on those cases may be specified. The bits in the energy-save need (ESN) field assume the value 0 for no need and the highest for strongest need.

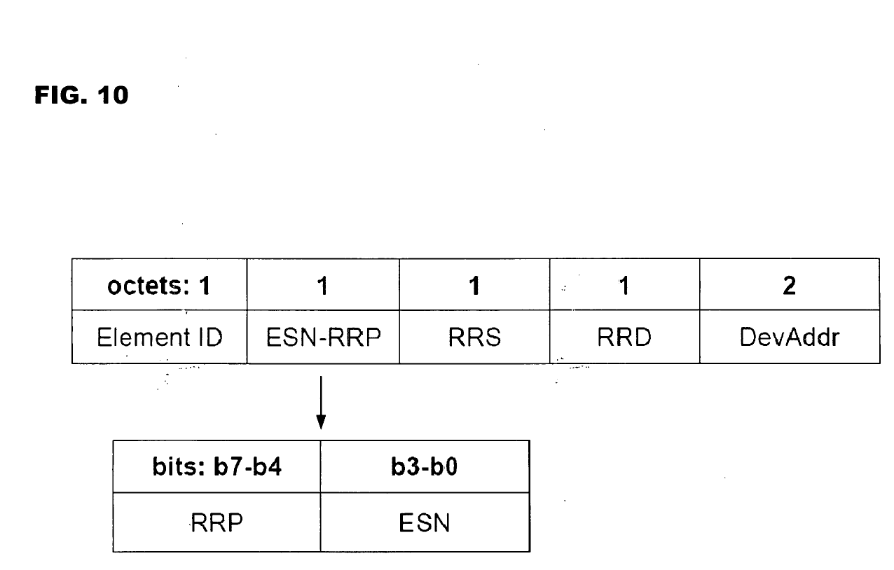

ESN: energy saving need. This field indicates the need of resources due to energy save need. A field with content other than zero shall be intended as a resource release request. The minimum size of an ESN is one bit where 0: false, 1: true. Alternatively, larger resolution may be obtained by having a few levels (e.g., four: two bits: 00: no need, 11: highest need, levels may be linked to residual energy). FIG. 10 discloses and an alternative example for the RR-IE in which the fields ESN and resource request priority (RRP) are joined into a single octet. An exemplary bitwise content of this combined ESN-RRP octet is further disclosed in the figure.

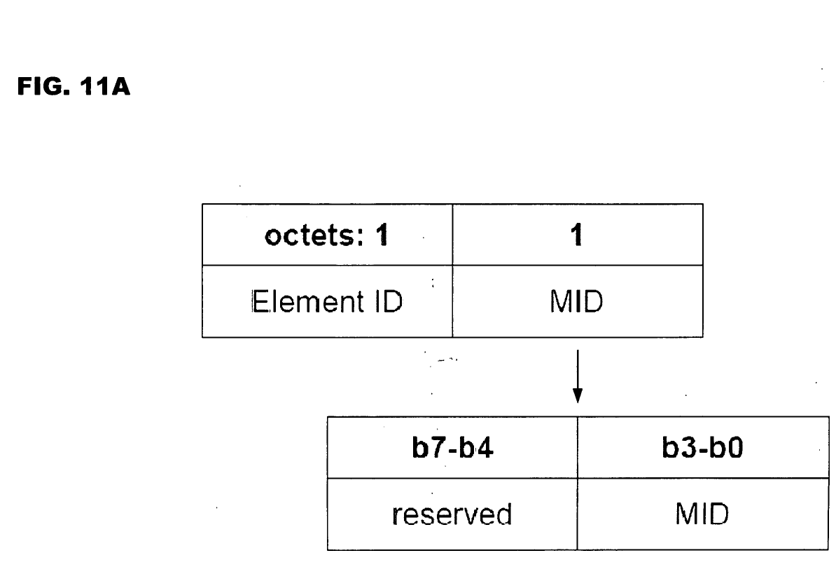

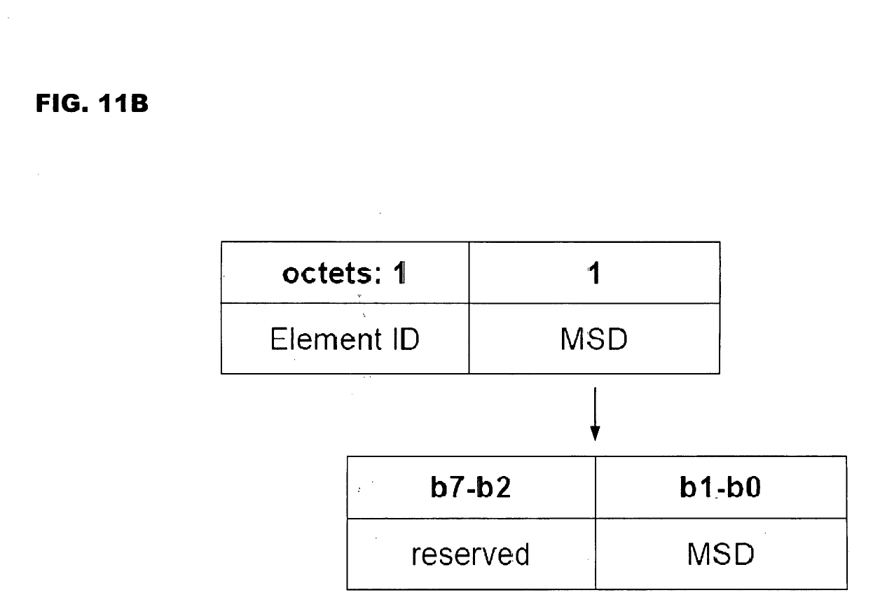

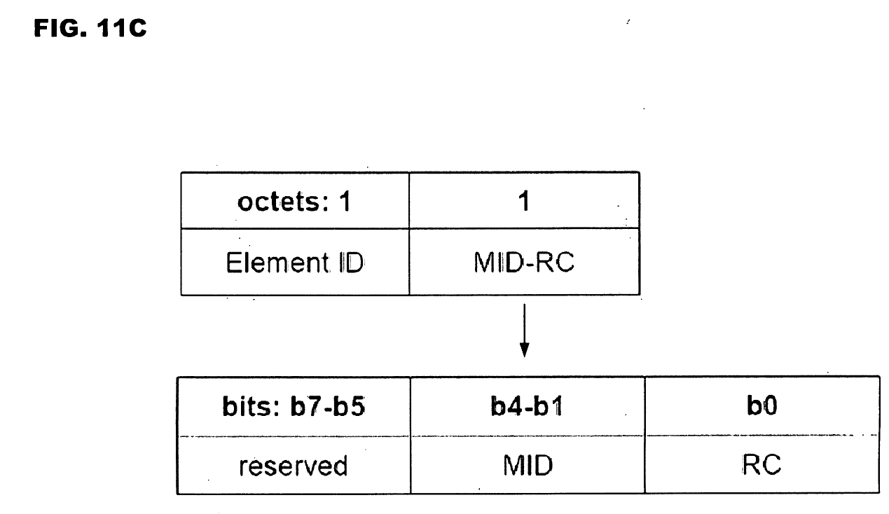

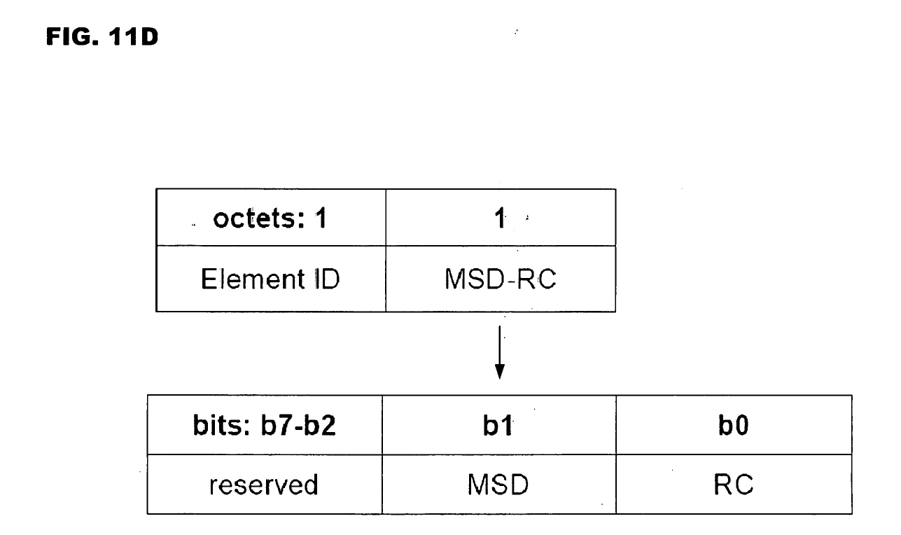

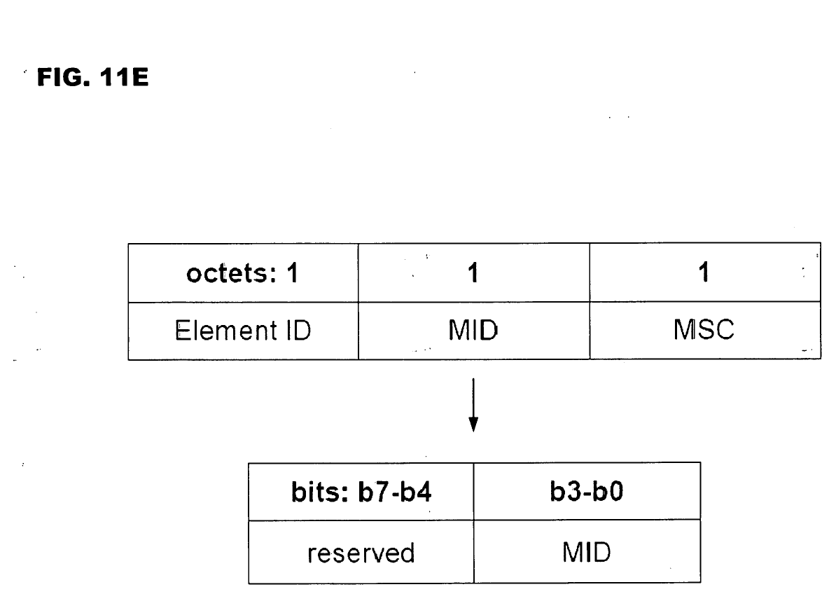

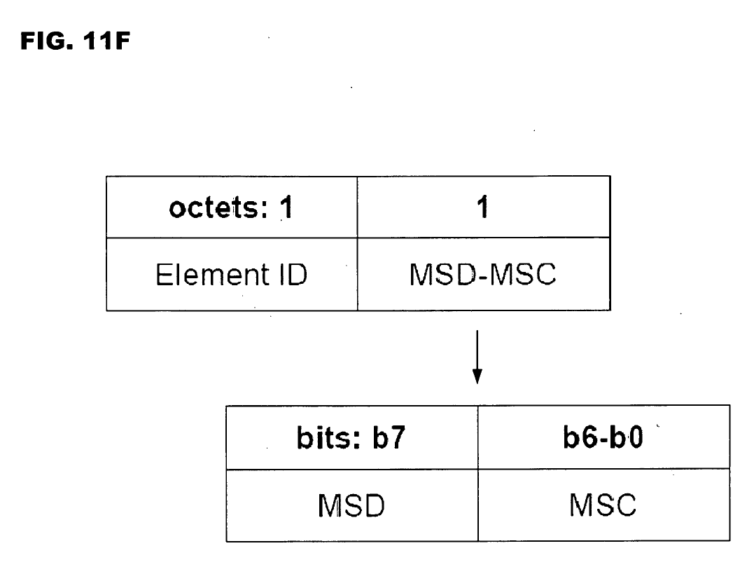

There may be a variety of fields that concern resource requests. RRS: size of requested resources. This is the size of the channel time requested. For example, this could be the number of MASs in WiMedia 1.x/ECMA-368. The size of this optional field may be for example 1 octet. RRD: time duration of the requested resources. This is the time duration the requested resources are needed. For example, the time can be denoted in superframes. The size of this optional field may be for example 1 octet. DevAddr: address of device target or the RRR. This field is used for explicit RRR. The size of this field is for example 2 octets. RRP: priority of the RRR. This field is used for supporting a hard RRR. MC-IE: mode change IE. This information element may be configured as follows, depending on the implementation (sizes in bits and octets): MID: 4 bits=1 octet; MSD(2): 2 bits=1 octet; MID+RC: 5 bits=1 octet; MSD(1)+RC: 2 bits=1 octet; MID+MSC: 2 octets; MSD(1)+MSC: 1 octet. FIG. 11A-11F disclose exemplary PHY-mode change IE (MC-IE) requests. Various configurations are possible depending on the implementation: FIG. 11A discloses PHY-mode ID MID (4 bits); FIG. 11B discloses PHY-mode switching direction MSD(2 bits); FIG. 11C discloses MID and RC, or MID-RC, (4+1=5 bits); FIG. 11D discloses MSD and rate change RC, or MSD-RC, (1+1=2 bits); FIG. 11E discloses MID and PHY-mode switching countdown MSC (4 bits+1 octet); and FIG. 11F discloses MSD and MSC, or MID-MSC,(1+7=8 bits).

MID: PHY-mode ID. The ID of the next PHY-mode to be used. This may be represented by 4 bits.

MSD: PHY-mode switching direction. This field indicates points to the next PHY-mode to be used. The size of MSD is one bit if another field (e.g., MSC) is used to indicate a transition will occur, e.g., 0: down, 1: up (the fact that a transition will occur may be implicit in the presence of MSD information). Alternatively, the size of MSD may be two bits, e.g.: 00: no change, 01: up, 10: down, 11: reserved.

MSC: PHY-mode switch countdown. This field may indicate the time or the number of superframes until the PHY-mode transition. One value, e.g., all ones may be reserved to indicate no change will occur. The size of MSC may be for example 1 octet. If the RR-IE is formed by MSD and MSC, the MSD bit can be taken from the same octet, slightly reducing the dynamic of MSC. A compressed version of this field may include only one bit, indicating a coming rate change; one bit: 0:normal operations, 1: coming rate change.

RC: rate change indicator. Indicates a coming rate change that may include one bit: 0: normal operations, 1: coming rate change.

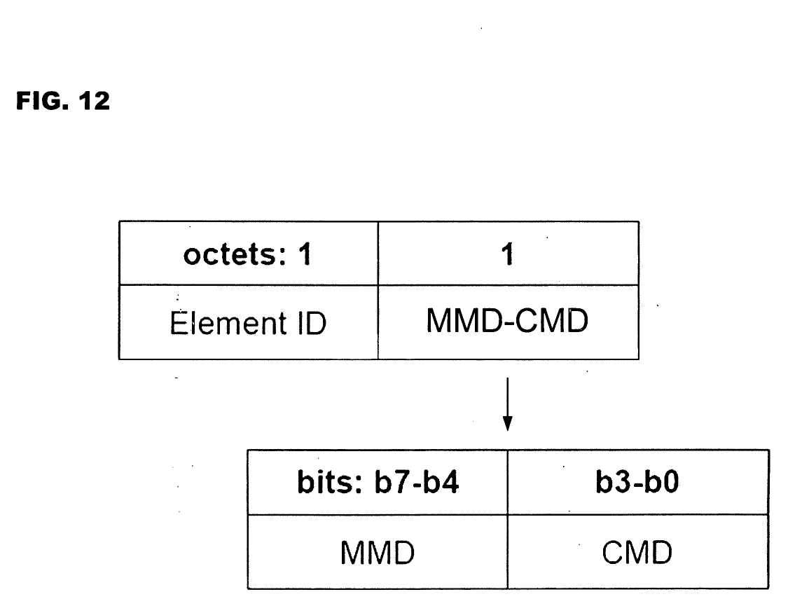

DMR-IE: higher rate capabilities. This IE includes CMD and MMD fields. FIG. 12 discloses an example of MMD-CMD.

CMD: current mode for data. ID of the PHY-mode currently used for data. This index addresses the mode in the PHY capabilities. The size of CMD is for example four bits.

MMD: highest-rate PHY mode ID. This may be the ID of the PHY-mode with the highest rate among the AMS. This index addresses the mode in the PHY capabilities. This field may be needed if AMS information is not available. The size of MMD may be for example four bits.

While various exemplary configurations of the present invention have been disclosed, the present invention is not strictly limited to the embodiments disclosed above.

For example, in accordance with at least one exemplary embodiment, the present invention may include a method comprising: monitoring one or more communication characteristics of a wireless transceiver communicating in a wireless communication medium, the communication characteristics including at least power consumption and an allowed communication error rate based on transmit rate; monitoring one or more communication characteristics of the wireless communication medium including at least an amount of reservations within the wireless communication medium; and triggering an operational mode change based on one or more threshold conditions relating to the monitored communication characteristics of the wireless transceiver and the wireless communication medium.

The prior exemplary method, wherein the power consumption is derived using a p(R) curve corresponding to the wireless transceiver.

The prior exemplary method, wherein the wireless transceiver is notified of an operational mode change.

The prior exemplary method, wherein the notification of an operational mode change is carried out using a MID (PHY-mode ID) field together with at least one of a MSC (PHY-mode switching countdown) or RC (rate change) fields. In addition this method may include, wherein the notification of an operational mode change is carried out using a MSD (PHY-mode switching direction) field together with at least one of the MSC or RC fields.

The prior exemplary method, wherein the operational mode change is made in response to a request to release resources from another wireless transceiver. In addition this method may include, wherein the operational mode change releases resources by changing to a higher rate operational mode. In addition this method may include, wherein the request to release resources in implicitly indicated through use of the ESN (energy-saving need) field. In addition this method may include, wherein the request to release resources is explicitly indicated by using the ESN field together with the DevAddr (device address) field. In addition this method may include, wherein a RRS (resource request, size) field is used with at least one of RR-IE (resource request or release request IE) field and RRD (resource request, duration) field to request that resources be released.

The prior exemplary method, wherein a usable operational mode is determined using the AMS-IE (active PHY-modes set information element) field. In addition this method may include, wherein the operational mode change further includes requesting the release of resources by using target wireless transceiver information included in CMD and MMD. In addition this method may include, wherein the operational mode change further includes requesting the release of resources by using target wireless transceiver information included in CMD together with the AMS-IE.

The prior exemplary method, wherein current and maximum rates of an operational mode are realized by using the CMD and MMD fields, wherein DMR-IE is composed of CMD (current PHY-mode for data) and MMD (highest-rate PHY-mode for data).

The prior exemplary method, wherein the wireless communication medium is related to ECMA-368. In addition this method may include, wherein an unsafe bit in a DRP (distributed reservation protocol) field is used to determine the existence of a target wireless transceiver to receive an explicit or implicit resource release request.

The prior exemplary method, wherein the change in operational mode releases resources according to at least one unsafe communication reservation portion in a wireless communication medium.

The prior exemplary method, wherein the change in operational mode releases resources according to monitored power level in a device utilizing the wireless transceiver.

The prior exemplary method, wherein the change in operational mode is a preemptive operation by issuing a hard resource release request by using a RRP (resource request priority) field. In addition this method may include, wherein the preemptive release of resources is made according to an increase in the number of wireless transceivers utilizing the wireless communication medium. In addition this method may include, wherein a maximum lifetime of a device engaged in a preemptive resource release is determined after the wireless transceiver returns to previous settings.

For example, in accordance with at least one exemplary embodiment, the present invention may include a computer program product comprising a computer usable medium having computer readable program code embodied in said medium, comprising: a computer readable program code configured to monitor one or more communication characteristics of a wireless transceiver communicating in a wireless communication medium, the communication characteristics including at least power consumption and an allowed communication error rate based on transmit rate; a computer readable program code configured to monitor one or more communication characteristics of the wireless communication medium including at least an amount of reservations within the wireless communication medium; and a computer readable program code configured to trigger an operational mode change based on one or more threshold conditions relating to the monitored communication characteristics of the wireless transceiver and the wireless communication medium.

The prior exemplary computer program product, wherein the power consumption is derived using a p(R) curve corresponding to the wireless transceiver.

The prior exemplary computer program product, wherein the wireless transceiver is notified of an operational mode change. In addition this computer program product may include, wherein the notification of an operational mode change is carried out using a MID (PHY-mode ID) field together with at least one of a MSC (PHY-mode switching countdown) or RC (rate change) fields. In addition this computer program product may include, wherein the notification of an operational mode change is carried out using a MSD (PHY-mode switching direction) field together with at least one of the MSC or RC fields.

The prior exemplary computer program product, wherein the operational mode change is made in response to a request to release resources from another wireless transceiver. In addition this computer program product may include, wherein the operational mode change releases resources by changing to a higher rate operational mode. In addition this computer program product may include, wherein the request to release resources in implicitly indicated through use of the ESN (energy-saving need) field. In addition this computer program product may include, wherein the request to release resources is explicitly indicated by using the ESN field together with the DevAddr (device address) field. In addition this computer program product may include, wherein a RRS (resource request, size) field is used with at least one of RR-IE (resource request or release request IE) field and RRD (resource request, duration) field to request that resources be released.

The prior exemplary computer program product, wherein a usable operational mode is determined using the AMS-IE (active PHY-modes set information element) field. In addition this computer program product may include, wherein the operational mode change further includes requesting the release of resources by using target wireless transceiver information included in CMD and MMD. In addition this computer program product may include, wherein the operational mode change further includes requesting the release of resources by using target wireless transceiver information included in CMD together with the AMS-IE.

The prior exemplary computer program product, wherein current and maximum rates of an operational mode are realized by using the CMD and MMD fields, wherein DMR-IE is composed of CMD (current PHY-mode for data) and MMD (highest-rate PHY-mode for data).

The prior exemplary computer program product, wherein the wireless communication medium is related to ECMA-368. In addition this computer program product may include, wherein an unsafe bit in a DRP (distributed reservation protocol) field is used to determine the existence of a target wireless transceiver to receive an explicit or implicit resource release request.

The prior exemplary computer program product, wherein the change in operational mode releases resources according to at least one unsafe communication reservation portion in a wireless communication medium.

The prior exemplary computer program product, wherein the change in operational mode releases resources according to monitored power level in a device utilizing the wireless transceiver.

The prior exemplary computer program product, wherein the change in operational mode is a preemptive operation by issuing a hard resource release request by using a RRP (resource request priority) field. In addition this computer program product may include, wherein the preemptive release of resources is made according to an increase in the number of wireless transceivers utilizing the wireless communication medium. In addition this computer program product may include, wherein a maximum lifetime of a device engaged in a preemptive resource release is determined after the wireless transceiver returns to previous settings.

For example, in accordance with at least one exemplary embodiment, the present invention may include a device comprising: at least one wireless communication module; and a processor, coupled to the wireless communication module, the processor further being configured to: monitor one or more communication characteristics of a wireless transceiver communicating in a wireless communication medium, the communication characteristics including at least power consumption and an allowed communication error rate based on transmit rate; monitor one or more communication characteristics of the wireless communication medium including at least an amount of reservations within the wireless communication medium; and trigger an operational mode change based on one or more threshold conditions relating to the monitored communication characteristics of the wireless transceiver and the wireless communication medium.

The prior exemplary device, wherein the power consumption is derived using a p(R) curve corresponding to the wireless transceiver.

The prior exemplary device, wherein the wireless transceiver is notified of an operational mode change. In addition this device may include, wherein the notification of an operational mode change is carried out using a MID (PHY-mode ID) field together with at least one of a MSC (PHY-mode switching countdown) or RC (rate change) fields. In addition this device may include, wherein the notification of an operational mode change is carried out using a MSD (PHY-mode switching direction) field together with at least one of the MSC or RC fields.

The prior exemplary device, wherein the operational mode change is made in response to a request to release resources from another wireless transceiver. In addition this device may include, wherein the operational mode change releases resources by changing to a higher rate operational mode. In addition this device may include, wherein the request to release resources in implicitly indicated through use of the ESN (energy-saving need) field. In addition this device may include, wherein the request to release resources is explicitly indicated by using the ESN field together with the DevAddr (device address) field. In addition this device may include, wherein a RRS (resource request, size) field is used with at least one of RR-IE (resource request or release request IE) field and RRD (resource request, duration) field to request that resources be released.

The prior exemplary device, wherein a usable operational mode is determined using the AMS-IE (active PHY-modes set information element) field. In addition this device may include, wherein the operational mode change further includes requesting the release of resources by using target wireless transceiver information included in CMD and MMD. In addition this device may include, wherein the operational mode change further includes requesting the release of resources by using target wireless transceiver information included in CMD together with the AMS-IE.

The prior exemplary device, wherein current and maximum rates of an operational mode are realized by using the CMD and MMD fields, wherein DMR-IE is composed of CMD (current PHY-mode for data) and MMD (highest-rate PHY-mode for data).

The prior exemplary device, wherein the wireless communication medium is related to ECMA-368. In addition this device may include, wherein an unsafe bit in a DRP (distributed reservation protocol) field is used to determine the existence of a target wireless transceiver to receive an explicit or implicit resource release request.

The prior exemplary device, wherein the change in operational mode releases resources according to at least one unsafe communication reservation portion in a wireless communication medium.

The prior exemplary device, wherein the change in operational mode releases resources according to monitored power level in a device utilizing the wireless transceiver.

The prior exemplary device, wherein the change in operational mode is a preemptive operation by issuing a hard resource release request by using a RRP (resource request priority) field. In addition this device may include, wherein the preemptive release of resources is made according to an increase in the number of wireless transceivers utilizing the wireless communication medium. In addition this device may include, wherein a maximum lifetime of a device engaged in a preemptive resource release is determined after the wireless transceiver returns to previous settings.

For example, in accordance with at least one exemplary embodiment, the present invention may include a system comprising: a plurality of wireless communication devices; at least one wireless communication device monitoring one or more communication characteristics of a wireless transceiver coupled to the at least one wireless communication device and communicating in a wireless communication medium, the communication characteristics including at least power consumption and an allowed communication error rate based on transmit rate; the at least one of the wireless communication devices monitoring one or more communication characteristics of the wireless communication medium including at least an amount of reservations within the wireless communication medium; and the at least one of the wireless communication device triggering an operational mode change based on one or more threshold conditions relating to a request for resources from another wireless communication device, the monitored communication characteristics of the wireless transceiver and the wireless communication medium.

For example, in accordance with at least one exemplary embodiment, the present invention may include a method comprising: monitoring one or more communication characteristics of a wireless transceiver communicating in a wireless communication medium, the communication characteristics including at least power consumption and an allowed communication error rate based on transmit rate; monitoring one or more communication characteristics of the wireless communication medium including at least an amount of reservations within the wireless communication medium; comparing the communication characteristics of the wireless transceiver and wireless communication medium to at least one proactive or reactive policy, wherein the proactive policy is based on maintaining a number of safe reservations for operating in a particular mode and the reactive policy is based on a threshold; and triggering an operational mode change based on the at least one policy.

For example, in accordance with at least one exemplary embodiment, the present invention may include a device comprising: at least one wireless communication module; and a processor, coupled to the wireless communication module, the processor further being configured to: monitor one or more communication characteristics of a wireless transceiver communicating in a wireless communication medium, the communication characteristics including at least power consumption and an allowed communication error rate based on transmit rate; monitor one or more communication characteristics of the wireless communication medium including at least an amount of reservations within the wireless communication medium; compare the communication characteristics of the wireless transceiver and wireless communication medium to at least one proactive or reactive policy, wherein the proactive policy is based on maintaining a number of safe reservations for operating in a particular mode and the reactive policy is based on a threshold; and trigger an operational mode change based on the at least one policy.

Accordingly, it will be apparent to persons skilled in the relevant art that various changes in forma and detail can be made therein without departing from the spirit and scope of the invention. The breadth and scope of the present invention should not be limited by any of the above-described exemplary embodiments, but should be defined only in accordance with the following claims and their equivalents.

### APPENDIX

### List of Abbreviations:

@ at
AM active [PHY] modes
AMS active [PHY] modes set
BP beacon period
CMD current [PHY] mode for data
DevAddr device address
DEVA device A
DEVA1 device A1
DEVA2 device A2
DEVB device B
DEVB1 device B1
DMR data [PHY] modes range
DRP distributed reservation protocol
DTP data transfer period
ECMA European computer manufactures association
ESN energy saving need
H high-rate, high-rate allocation
ID identifier
IE information element
IEEE The Institute of Electrical and Electronics Engineers
ISO International Organization for Standardization
L low-rate, low rate allocation
L1 ISO-OSI layer 1
L2 ISO-OSI layer 2
MAS medium access slot
MC [PHY] mode change
MID [PHY] mode ID
MMD highest-rate [PHY] mode ID
MPC [PHY] mode power curve
MSC [PHY] mode switching countdown
MSD [PHY] mode switching direction
OSI Open Systems Interconnection
PCA prioritized contention access
PHy physical layer
RC rate change indicator
RR resource request
RRD time duration of requested resources RRP resource request priority
RRR release resource request RRS size of requested resources
SF superframe
SINR signal to noise ratio
SNR signal to interference-plus-noise ratio

### List of Symbols:

a activity factor
E energy consumption
EB energy expenditure in active mode, common to transmit and receive operations
EH energy expenditure in high-rate mode
EHR energy expenditure in high-rate mode for receive operations
EHT energy expenditure in high-rate mode for transmit operations
EK bulk energy expenditure in active period
EL energy expenditure in low-rate mode
ELR energy expenditure in low-rate mode for receive operations
ELT energy expenditure in low-rate mode for transmit operations
f( ) function
L protocol data unit length
nH number of MASs in high-rate mode
nL number of MASs in low-rate mode
nM number of MASs
OL occupation level
p( ) power level
pD deep sleep power level
pH high-rate mode power level
pK awake bulk power level
pL low-rate mode power level
pS sleep power level
R rate
RH high-rate
RL low-rate
t time instant (as in t0, t1, t2, t3, t4, t5, t5 ,t6, t7, t8, t9)
t( ) time
Tav available channel time
tB active time
Tdtp DTP duration
tK awake time
tM MAS duration
Tocc average channel time occupation
tR transmission time
tT reception time
X implementation dependent quantity
x generic variable
YYY implementation dependent quantity
y generic variable

### Definitions:

Active is a device engaged in either reception or transmission operations. Awake is a device outside energy saving mode, like hibernation. Inactive is an awake device not engaged in >reception or transmission operations.
PHY-mode is a specific selection from a sub-set of the possible combinations of, e.g., modulation constellation, forward error correction channel coding scheme, and any other property of the air interface related to transmit speed and energy consumption.

What is claimed:

1. A method comprising:
determining that activity in an apparatus will require access to a communication resource;
reserving, based on the activity, one or more timeslots during which access to the communication resource is permitted;
determining if any of the one or more timeslots is associated with a low rate transmission mode;
identifying at least some of the one or more timeslots as safe based on the activity and the low rate transmission mode determination, wherein the number of timeslots identified as safe is subject to a predetermined threshold value; and
identifying any remaining unidentified timeslots as unsafe.

2. The method of claim 1, wherein the one or more timeslots identified as safe cannot be released without substantial impact to the communication operation of the apparatus.

3. The method of claim 1, wherein the predetermined threshold value corresponds to a maximum number of timeslots that can be identified as safe by the apparatus.

4. The method of claim 1, wherein the identification of the one or more timeslots as safe or unsafe is communicated to other apparatuses in the wireless communication network as part of an information element that is sent within a beacon signal.

5. The method of claim 4, wherein the identification comprises at least one bit set within a distributed reservation protocol data element (DRP-IE).

6. The method of claim 1, further comprising receiving a resource request to release at least one of the unsafe timeslots.

7. The method of claim 6, further comprising releasing the requested at least one of the unsafe timeslots; and
determining whether any remaining timeslots are associated with a low rate transmission mode.

8. The method of claim 7, further comprising determining whether to change any of the remaining timeslots associated with a low rate transmission mode to be associated with a high rate transmission mode.

9. A computer program product comprising a computer usable medium having computer readable program code embodied in said medium, comprising:
a computer readable program code configured to determine that activity in an apparatus will require access to a communication resource;
a computer readable program code configured to reserve, based on the activity, one or more timeslots during which access to the communication resource is permitted;
a computer readable program code configured to determine if any of the one or more timeslots is associated with a low rate transmission mode;
a computer readable program code configured to identify at least some of the one or more timeslots as safe based on the activity and the low rate transmission mode determination, wherein the number of timeslots identified as safe is subject to a predetermined threshold value; and
a computer readable program code configured to identify any remaining unidentified timeslots as unsafe.

10. The computer program product of claim 9, wherein the one or more timeslots identified as safe cannot be released without substantial impact to the communication operation of the apparatus.

11. The computer program product of claim 9, wherein the predetermined threshold value corresponds to a maximum number of timeslots that can be identified as safe by the apparatus.

12. The computer program product of claim 9, wherein the identification of the one or more timeslots as safe or unsafe is communicated to other apparatuses in the wireless communication network as part of an information element that is sent within a beacon signal.

13. The computer program product of claim 12, wherein the identification comprises at least one bit set within a distributed reservation protocol data element (DRP-IE).

14. The computer program product of claim 9, further comprising receiving a resource request to release at least one of the unsafe timeslots.

15. The computer program product of claim 14, further comprising releasing the requested at least one of the unsafe timeslots; and
determining whether any remaining timeslots are associated with a low rate transmission mode.

16. The computer program product of claim 15, further comprising determining whether to change any of the remaining timeslots associated with a low rate transmission mode to be associated with a high rate transmission mode.

17. An apparatus, comprising:
a processor, the processor further being configured to:
determine that activity will require access to a communication resource;
reserving, based on the activity, one or more timeslots during which access to the communication resource is permitted;
determining if any of the one or more timeslots is associated with a low rate transmission mode;
identifying at least some of the one or more timeslots as safe based on the activity and the low rate transmission mode determination, wherein the number of timeslots identified as safe is subject to a predetermined threshold value; and
identifying any remaining unidentified timeslots as unsafe.

18. The apparatus of claim 17, wherein the one or more timeslots identified as safe cannot be released without substantial impact to the communication operation of the apparatus.

19. The apparatus of claim 17, wherein the predetermined threshold value corresponds to a maximum number of timeslots that can be identified as safe by the apparatus.

20. The apparatus of claim 17, wherein the identification of the one or more timeslots as safe or unsafe is communicated to other apparatuses in the wireless communication network as part of an information element that is sent within a beacon signal.

21. The apparatus of claim 20, wherein the identification comprises at least one bit set within a distributed reservation protocol data element (DRP-IE).

22. The apparatus of claim 17, further comprising receiving a resource request to release at least one of the unsafe timeslots.

23. The apparatus of claim 22, further comprising releasing the requested at least one of the unsafe timeslots; and
determining whether any remaining timeslots are associated with a low rate transmission mode.

24. The apparatus of claim 23, further comprising determining whether to change any of the remaining timeslots associated with a low rate transmission mode to be associated with a high rate transmission mode.

25. An apparatus, comprising:
means for determining that activity in an apparatus will require access to a communication resource;
means for reserving, based on the activity, one or more timeslots during which access to the communication resource is permitted;
means for determining if any of the one or more timeslots is associated with a low rate transmission mode;
means for identifying at least some of the one or more timeslots as safe based on the activity and the low rate transmission mode determination, wherein the number of timeslots identified as safe is subject to a predetermined threshold value; and
means for identifying any remaining unidentified timeslots as unsafe.

26. A system comprising:
a plurality of apparatuses;
at least one apparatus determining that activity will require access to a communication resource and reserving, based on the activity, one or more timeslots during which access to the communication resource is permitted;
the at least one apparatus further determining if any of the one or more timeslots is associated with a low rate transmission mode;
the at least one apparatus further identifying at least some of the one or more timeslots as safe based on the activity and the low rate transmission mode determination, wherein the number of timeslots identified as safe is subject to a predetermined threshold value, and identifying any remaining unidentified timeslots as unsafe.
